(19) United States
(12) Patent Application Publication
(10) Pub. No.: US 2020/0310507 A1
(43) Pub. Date: Oct. 1, 2020

(54) GENERATING POWER SIGNATURES FOR ELECTRONIC DEVICES

(71) Applicant: HEWLETT-PACKARD DEVELOPMENT COMPANY, L.P., Houston, TX (US)

(72) Inventor: David H. HANES, Fort Collins, CO (US)

(73) Assignee: Hewlett-Packard Development Company, L.P., Houston, TX (US)

(21) Appl. No.: 16/089,272

(22) PCT Filed: Mar. 29, 2016
(86) PCT No.: PCT/US2016/024664

§ 371 Date: Sep. 27, 2018

(51) Int. Cl. G06F 1/28

(52) U.S. Cl. CPC G06F 1/28

(57) ABSTRACT

Examples disclosed herein provide the ability to determine a power signature of an electronic device. In one example, a controller may track power usage of the electronic device over a period of time, and generate a power signature for the electronic device, based on how the electronic device is being used over the period of time. As an example, the controller may use the power signature to determine a stage the electronic device is in at a particular moment in time.

### BACKGROUND

The Internet of Things (IoT) refers to a network of objects, embedded with electronics, software, sensors, and network connectivity, that enables these objects to collect and exchange data. For example, IoT allows objects to be sensed and controlled remotely across an existing network infrastructure. Examples of such objects in a home setting include appliances, various other devices, and lights, all controlled in an intelligent manner. An interconnection of such embedded devices has the potential to usher in automation in nearly all fields.

### BRIEF DESCRIPTION OF THE DRAWINGS

FIG. 1 illustrates a system including an electronic device that may be monitored by a mechanism for performing IoT-related activities, according to an example;

FIG. 2 is a block diagram depicting a memory device and a processor, according to one example; and

FIG. 3 is a flow diagram in accordance with an example of the present disclosure.

### DETAILED DESCRIPTION

Numerous electronic devices may not have such sensors and network connectivity to exchange data and communicate with other electronic devices, for example, in a home. Examples disclosed herein provide the ability for such electronic devices to be monitored by a mechanism that may be coupled with the device. Upon monitoring such an electronic device by a mechanism, the mechanism may provide the ability to track power usage of the electronic device, and use such information to perform various IoT-related activities. For example, a controller may obtain such information, as collected by the mechanism, to build a database of the power consumption of the electronic device over time, known as the power signature of the electronic device, and rely on the power signature to determine what the electronic device is doing at a particular point in time. By collecting power signatures of other electronic devices, for example, in the home, via mechanisms coupled to the other electronic devices, the controller may be able to make smarter decisions or provide cost effective solutions throughout the home.

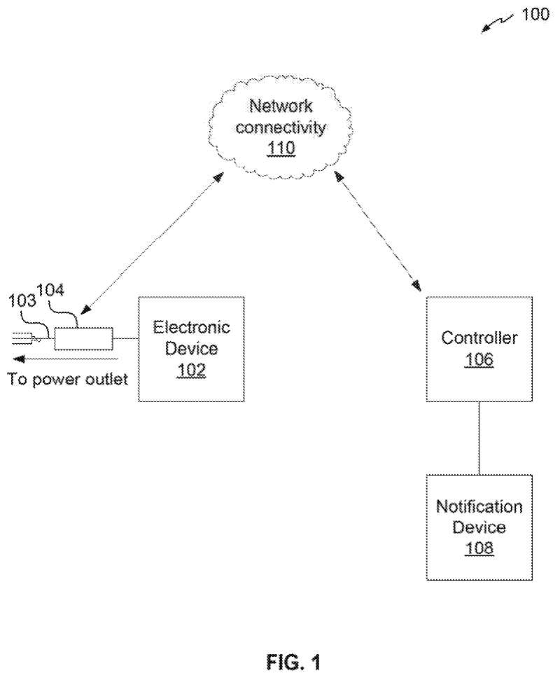

With reference to the figures, FIG. 1 illustrates a system 100 including an electronic device 102 that may be monitored by a mechanism 104 for performing IoT-related activities, according to an example. As mentioned above, the electronic device 102 may not have the sensors and network connectivity to exchange data and communicate with other electronic devices. However, the electronic device 102 may be coupled or retrofitted with the mechanism 104 in order to collect such information from the electronic device 102 and send to a controller 106, for example, over a network connectivity 110. As an example, the mechanism 104 and controller 106 may exchange communications via the network connectivity 110 using a wired network connectivity (e.g., Ethernet) or a wireless or mobile communications technology, such as Wi-Fi, 3G, or 4G. As an example, the controller 106 may be a computing device, such as a personal computer, that monitors a number of electronic devices, for example, in a home.

As an example, the mechanism 104 may be coupled or retrofitted to the electronic device 102 in order to track a power usage of the electronic device 102. While the mechanism 104 is tracking the power usage of the electronic device 102, when the power usage changes by a significant amount or by a threshold amount, the mechanism 104 may determine that the electronic device 102 is switching between different stages. As a result, the mechanism 104 may send a signal or communicate the change in power usage to the controller 106. As an example, the mechanism 104 may continually send power usage information to the controller 106, or at regular time intervals, and the controller 106, rather than the mechanism 104, may determine whether the electronic device 102 is switching between different stages.

As an example, if the electronic device 102 is a dishwasher, the dishwasher may have different power draws depending on, for example, if the dishwasher is drying dishes with a heating element, or running a water pump. Similarly, a washing machine may use more power during a spin cycle than an agitation phase. By being coupled to the mechanism 104, the mechanism 104 may be able to determine when the electronic device 102 switches between different stages (or the controller 106, as described above). As will be further described, a power signature may be generated based on the changes in power usage detected by the mechanism 104. Also, during a training phase, for example, when the mechanism 104 is initially coupled to the electronic device 102, a description may be entered anytime the mechanism 104 detects a change in power usage (e.g., by a significant amount or over a threshold amount), in order to assign an appropriate description for each power stage detected by the mechanism 104.

As an example, the mechanism 104 may monitor power flowing through a power cord 103 of the electronic device 102. As examples, the mechanism 104 may be an in-line mechanism, or one that can go around the power cord 103 of the electronic device 102. With regards to an in-line mechanism, the mechanism 104 may plug into a power outlet, and then the power plug of the electronic device 102 may plug into the mechanism 104. With regards to the mechanism 104 going around or wrapping around the power cord 103 of the electronic device 102, the mechanism 104 may measure the current draw of the electronic device 102 inductively, like an inductive ammeter.

With the mechanism 104 having the ability to track the power usage of the electronic device 102, rather than just monitoring the power draw of the electronic device 102 at any given moment, the mechanism 104 may also send power draw information on a regular time interval to the controller 106. For example, the mechanism 104 may send such power draw information when the power usage of the electronic device 102 changes by a threshold amount over the period of time, or the controller 106 may determine such changes when the mechanism 104 sends the power draw information at regular time intervals. Upon receiving such information, the controller 106 may then build a database of the power consumption of the electronic device 102 over time, essentially generating a power signature for the electronic device 102. The power signature for an electronic device may be defined as the power consumption response to workloads or programs executed by the electronic device, and provide a picture of the power consumption of the electronic device while it is in its various stages.

Once the power signature for the electronic device 102 is generated, the controller 106 may use the power signature generated for the electronic device 102, and the power usage of the electronic device 102 at a particular moment in time, as detected by the mechanism 104, to determine what the electronic device 102 is doing at that particular moment in time. For example, the controller 106 may determine whether the electronic device 102 is turned on or off, or whether the electronic device 102 is changing from one state to another.

As mentioned above, during a training phase, for example, when the mechanism 104 is initially coupled to the electronic device 102, a description may be entered anytime the mechanism 104 detects a change in power usage. This training phase may coincide with when the power signature of the electronic device 102 is generated, in order to provide an appropriate description for each stage of the electronic device 102. As an example, when a change in power usage is detected for a washing machine when it enters an agitation phase, it may be labeled as such. Similarly, when a different power usage is detected, for example, when the washing machine enters a spin cycle, it may be labeled as well. As an example, such descriptions, as entered by a user during a training phase, may be uploaded to a website, and made available for others with the same or similar electronic device 102 (e.g., similar mode of washing machine), to download. As a result, the training phase may not have to be performed by other users.

As an example, once a power signature for the electronic device 102 has been generated, a user may desire to receive notifications, for example, via a notification device 108, when the electronic device 102 has begun or completed a stage, as specified by the user. Examples of notification devices include, but are not limited to, a computing device, such as a smartphone, or speaker connected to the controller 106 wired or wirelessly (e.g., via Bluetooth). As an example, the controller 106 may use the power signature generated for the electronic device 102, and the power usage of the electronic device 102, as detected by the mechanism 104, to determine when the power usage of the electronic device 102 matches with the stage specified by the user. Once the controller 106 determines that the electronic device 102 has begun or completed the specified stage, the user may receive the notification via the notification device 108.

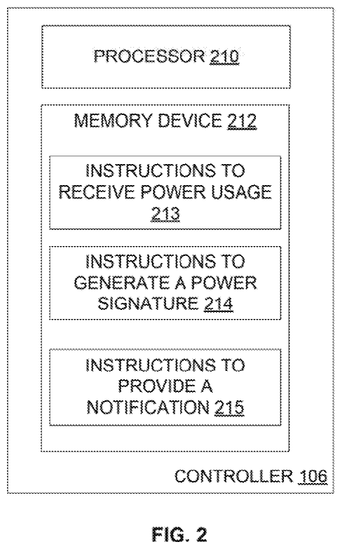

FIG. 2 is a block diagram depicting a memory device 212 and a processor 210 of the controller 106, according to an example. As an example of the controller 106 performing its operations, the memory device 212 may include instructions 213-215 that are executable by the processor 210. Thus, memory device 212 can be said to store program instructions that, when executed by processor 210, implement the components of the controller 106.

Memory device 212 represents generally any number of memory components capable of storing instructions that can be executed by processor 210. Memory device 212 is non-transitory in the sense that it does not encompass a transitory signal but instead is made up of at least one memory component configured to store the relevant instructions. As a result, the memory device 212 may be a non-transitory computer-readable storage medium. Memory device 212 may be implemented in a single device or distributed across devices. Likewise, processor 210 represents any number of processors capable of executing instructions stored by memory device 212. Processor 210 may be integrated in a single device or distributed across devices. Further, memory device 212 may be fully or partially integrated in the same device as processor 210, or it may be separate but accessible to that device and processor 210.

In one example, the program instructions can be part of an installation package that when installed can be executed by processor 210 to implement the components of the controller 106. In this case, memory device 212 may be a portable medium such as a CD, DVD, or flash drive or a memory maintained by a server from which the installation package can be downloaded and installed. In another example, the program instructions may be part of an application or applications already installed. Here, memory device 212 can include integrated memory such as a hard drive, solid state drive, or the like.

In FIG. 2, the executable program instructions stored in the memory device 212 include instructions to receive power usage 213, instructions to generate a power signature 214, and instructions to provide a notification 215. Instructions to receive a power usage 213 represent program instructions that when executed by the processor 210 cause the controller to receive power usage information, for example, from the mechanism 104 coupled to the electronic device 102 (see FIG. 1). Instructions to generate a power signature 214 represent program instructions that when executed by the processor 210 cause the controller 106 to generate a power signature of the electronic device 102 based on the power usage information received from the mechanism 104. Instructions to provide a notification 215 represent program instructions that when executed by the processor 210 cause the controller 106 to provide a notification, for example, via the notification device 108, when the electronic device 102 has begun or completed a stage, as specified by a user.

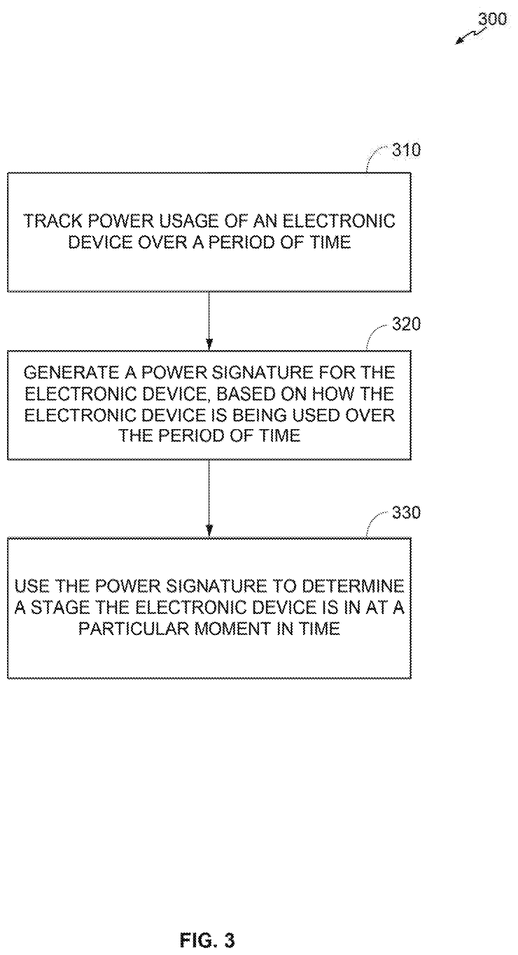

FIG. 3 is a flow diagram 300 of steps taken to implement a method for determining a power signature of an electronic device, for example, by a controller. In discussing FIG. 3, reference may be made to the example scenario illustrated in FIG. 1. Such reference is made to provide contextual examples and not to limit the manner in which the method depicted by FIG. 3 may be implemented.

At 310, the controller may track power usage of the electronic device over a period of time. As an example, the controller may track the power usage by receiving the power usage from a mechanism monitoring power flowing through a power cord of the electronic device. As an example, the mechanism plugs in between the power cord and a power outlet or wraps around the power cord to measure current inductively.

At 320, the controller may generate a power signature for the electronic device, based on how the electronic device is being used over the period of time. As an example, the controller may generate the power signature by detecting instances when the power usage of the electronic device changes by a threshold amount over the period of time. At 330, the controller may use the power signature to determine a stage the electronic device in in at a particular moment in time.

Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present invention.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
tracking power usage of an electronic device over a period of time;
generating a power signature for the electronic device, based on how the electronic device is being used over the period of time; and
using the power signature to determine a stage the electronic device is in at a particular moment in time.

2. The method of claim 1, wherein tracking power usage of the electronic device comprises monitoring power flowing through a power cord of the electronic device.

3. The method of claim 2, wherein the power flowing through the power cord of the electronic device is monitored via a mechanism that plugs in between the power cord and a power outlet.

4. The method of claim 2, wherein the power flowing through the power cord of the electronic device is monitored via a mechanism that wraps around the power cord to measure current inductively.

5. The method of claim 1, wherein generating the power signature for the electronic device comprises detecting instances when the power usage of the electronic device changes by a threshold amount over the period of time.

6. The method of claim 5, comprising receiving a description of what the electronic device is doing when each instance is detected.

7. The method of claim 6, comprising uploading descriptions of what the electronic device is doing when each instance is detected, in order to make accessible the descriptions for other users with the same electronic device.

8. The method of claim 1, comprising providing a notification via a notification device when the electronic device has completed a specified stage, wherein completion of the specified stage is determined by relying on the power signature for the electronic device.

9. A system comprising:
an electronic device;
a mechanism coupled to the electronic device, wherein the mechanism is to track power usage of the electronic device over a period of time; and
a controller to receive, from the mechanism, the power usage of the electronic device over the period of time and generate a power signature for the electronic device.

10. The system of claim 9, comprising a notification device to provide a notification when the electronic device has completed a specified stage, wherein completion of the specified stage is determined by relying on the power signature for the electronic device.

11. The system of claim 9, wherein the mechanism is to track the power usage of the electronic device by monitoring power flowing through a power cord of the electronic device.

12. The system of claim 11, wherein the mechanism is to plug in between the power cord and a power outlet.

13. The system of claim 11, wherein the mechanism wraps around the power cord to measure current inductively.

14. A non-transitory computer-readable storage medium comprising programming instructions which, when executed by a processor, to cause the processor to:
receive power usage of an electronic device over a period of time;
generate a power signature for the electronic device, based on how the electronic device is being used over the period of time; and
provide a notification when the electronic device has completed a specified stage, wherein completion of the specified state is determined by relying on the power signature for the electronic device.

15. The non-transitory computer-readable storage medium of claim 14, wherein the instructions to cause the processor to generate the power signature comprises instructions to cause the processor to detect instances when the power usage of the electronic device changes by a threshold amount over the period of time.
